(19) United States
(12) Patent Application Publication
(10) Pub. No.: US 2010/0162164 A1
(43) Pub. Date: Jun. 24, 2010

(54) METHOD AND APPARATUS FOR PROVIDING SEARCH SERVICE DURING PROGRAM BROADCASTING

(75) Inventors: Seok Cheon KWON, Gwacheon-si (KR); Cham Ko, Seoul (KR); Eun Ju Bae, Seoul (KR)

Correspondence Address: H.C. PARK & ASSOCIATES, PLC, 8500 LEESBURG PIKE, SUITE 7500, VIENNA, VA, 22182, US

(73) Assignee: NHN Corporation, Seongnam-si (KR)

(21) Appl. No.: 12/642,377

(22) Filed: Dec. 18, 2009

(30) Foreign Application Priority Data
Dec. 19, 2008 (KR) 10-2008-0130403

(51) Int. Cl. G06F 17/30; G06F 3/048

(52) U.S. Cl. 715/803; 707/706; 715/808; 707/E17.016

(57) ABSTRACT

The invention relates to a method and system for providing a search service to a bidirectional broadcasting terminal during program broadcasting. The invention includes providing a search area for a search service on a screen of the broadcasting terminal in response to key input, providing a first search window to display a representative keyword automatically being as an input with a search word based on an identification of the program, providing a second search window adjacent to the first search window to display a program-related search word automatically being as an input with a completion form of a search word, and providing a third search window adjacent to at least one of the first or second search windows and to display a real-time hot-topic search word automatically being as an input. The second and third search windows to provide an extended pop-up window including a modified word of the search word displayed on the respective search window in response to a selection by a user.

### CROSS REFERENCE TO RELATED APPLICATION

This application claims priority from and the benefit of Korean Application No. 10-2008-0130403, filed on Dec. 19, 2008, which is hereby incorporated by reference for all purposes as if fully set forth herein.

### BACKGROUND OF THE INVENTION

1. Field of the Invention

Exemplary embodiments of the present invention relate to a method and an apparatus for providing a search service during program broadcasting and, more particularly, to a method and apparatus for providing a search service that allow a user to use a search service using a bidirectional terminal while watching a certain program.

2. Description of the Background

With the advent of computers, interactive electronic communications, and the Internet, as well as advances in the digital realm of consumer information, bidirectional broadcasting services such as video-on-demand, data broadcasting, T-commerce, and internet protocol television (IPTV) services have been developed.

For example, bidirectional broadcast service is currently offers subscribers various services including identical broadcast content service to all users, And various broadcast contents to users with video applications enable robust programming information, selection, and navigation functionality, as well as integrated digital video recording, and data services to enhance the video experience, which support user demand, services can be selected directly by the users via return channels.

Further, internet protocol television (IPTV) service providers are currently offering subscribers various video services ranging from multi-channel video programming that mimics traditional broadcasting television, to true video-on-demand (VOD) programming.

It is recognized that modern lifestyles have become so reliant on digital interfaces that media devices such as electronic program guide (EPG) service provides a variety of program information, and a digital broadcasting receiver such as a set-top box (STB) that are developing into important information of media content (e.g., EPG service) accessibility. As such, an increasing number of individuals are utilizing STB to achieve the advantages of ubiquitous access to information and entertainment. Therefore, there is a need for an approach that seamlessly provides a flexible, efficient search scheme so that a user can easily search for desired services and programs.

### SUMMARY OF THE INVENTION

Exemplary embodiments of the present invention provide a device having a touch screen and a method for changing data on a touch screen of the device.

Additional features of the invention will be set forth in the description which follows, and in part will be apparent from the description, or may be learned by practice of the invention.

Exemplary embodiments of the present invention disclose a method for providing search service. The method includes receiving a search request from a user terminal during a broadcast program. The method includes determining whether the search request matches with criteria of a search engine for providing a first search window to the search area. The first search window is configured to display a representative keyword that is automatically provided as an input for searching. And the criteria for the matching is based on an identification of the broadcast program. The method includes determining whether the search request matches with the criteria for providing a second search window formed adjacent to the first search window. The second search window is configured to display a search word that is related to the broadcast program and the search word is a completed search word automatically being provided as an input. The method also includes determining whether the search request matches with the criteria for providing a third search window formed adjacent to at least one of the first search window and the second search window. The third search window is configured to display a real-m time hot-topic search word automatically being provided as an input. The method further includes providing a search window based on the determination.

Exemplary embodiments of the present invention disclose a method for providing a search service. The method includes receiving a search service request from a bidirectional broadcasting terminal in response to an input key of a user input unit. The method includes determining the search service request based on a rule of a search engine including a search providing module according to the determination of the input key action based on the rule. The method also includes populating a first search window, the first search window displaying a representative keyword automatically being selected as the input key based on an identification of a broadcast content. The method includes populating a second search window, the second search window to display a search word relating to the broadcast content and the search word automatically being selected as the input key with a completion of the search word. The method further includes populating a third search window, the third search window to display a real-time hot-topic search word automatically being selected as the input key. The populating the respective search window is based on the determination according the rule of the search engine.

Exemplary embodiments of the present invention disclose a system for providing a search service. The system includes a search log database to store search log data collected by a search engine. The system includes a recommendable search word extraction module to generate a program related keyword and a modified word of the program related keyword based on the search log data. The system also includes a real-time search word extraction module to generate a real-time hot-topic search word and a modified word of the real-time hot-topic search word based on the search log data. The system further includes a search area-providing module to provide a search area including a plurality of search windows in response to a search service request from a bidirectional broadcasting terminal, the plurality of search windows to display the program-related keyword and the real-time hot-topic search word automatically being displayed as an input.

Exemplary embodiments of the present invention disclose a non-transitory computer-readable recording medium comprising an executable program, which when executed, performs the steps of providing a search area for providing a search service on a screen of the bidirectional broadcasting terminal in response to key input of a user input unit. The step includes receiving a search request from a user terminal during a broadcast program. The step also includes determining whether the search request matches with criteria of a search engine for providing a first search window to the search area, wherein the first search window is to display a representative keyword that is automatically provided as an input for searching. The criteria for the matching is based on an identification of the broadcast program. The step includes determining whether the search request matches with the criteria for providing a second search window formed adjacent to the first search window. And the second search window is to display a search word that is related to the broadcast program and the search word is a completed search word automatically provided as an input. The step further includes determining whether the search request matches with the criteria for providing a third search window formed adjacent to at least one of the first search window and the second search window. And the third search window is to display a real-time hot-topic search word automatically provided as an input. The step includes providing a search window based on the determination. And each of the second search window and third search window provide an extended pop-up window including a modified word of the search word displayed on the corresponding search window in response to a selection of the corresponding search window.

It is to be understood that both the foregoing general description and the following detailed description are exemplary and explanatory and are intended to provide further explanation of the invention as claimed

### BRIEF DESCRIPTION OF THE DRAWINGS

The accompanying drawings, which are included to provide a further understanding of the invention and are incorporated in and constitute a part of this specification, illustrate exemplary embodiments of the invention, and together with the description serve to explain the principles of the invention.

FIG. 1 is a diagram of a system capable of searching for additional information of broadcast content according to exemplary embodiments of the present invention.

FIG. 2 is a diagram of an IPTV broadcast service system deploying a broadcaster, a set-top box, and a user terminal configured to provide broadcast service, according to exemplary embodiments of the present invention.

FIG. 3 is a diagram of a system capable of providing a searching service during a program, according to exemplary embodiments of the present disclosure.

FIG. 4 is a block diagram of the system for providing a search service during a program, according to exemplary embodiments of the present invention.

FIG. 5 is diagram for providing a recommendable search word extraction module by generating a recommendable keyword searching scheme for each program, according to exemplary embodiments of the present invention.

FIG. 6, FIG. 7, FIG. 8, FIG. 9 and FIG. 10 are graphical screens showing searching areas displayed on a terminal for providing a search service functions during a program, according to exemplary embodiments of the present invention.

FIG. 11 is a flowchart of a process for providing a search service during a program according to exemplary embodiments of the present invention.

FIG. 12 is a diagram of a computer system that can be used to implement various exemplary embodiments.

### DETAILED DESCRIPTION OF THE ILLUSTRATED EMBODIMENTS

The invention is described more fully hereinafter with reference to the accompanying drawings, in which exemplary embodiments of the invention are shown. This invention may, however, be embodied in many different forms and should not be construed as limited to the exemplary embodiments set forth herein. Rather, these exemplary embodiments are provided so that this disclosure is thorough, and will fully convey the scope of the invention to those skilled in the art. In the drawings, the size and relative sizes of layers and regions may be exaggerated for clarity. Like reference numerals in the drawings denote like elements.

Although the various exemplary embodiments are described with respect to an IPTV being used as a bidirectional broadcasting terminal, it is contemplated that the exemplary embodiments have applicability to various types of terminals being employed as a bidirectional broadcasting terminal, for example, a Television (TV), a computer, a mobile computer, a cellular handset (or phone), a cordless phone, a mobile transmitter, a stationary wireless transmitter, a wireless personal digital assistant (PDA), a wireless modem, or a pager as long as the terminal can perform bidirectional communication and can be used for broadcasting systems.

For example, a search area can be configured to a TV screen and the search area including a search window to display a search word related to a program which is currently on air. A representative keyword, a program-related search word and/or a real-time hot-topic search word can be used to facilitate for searching the Internet. However, an input unit such as a remote controller may lack of searching function due to limitation of input key functions of the remote controller.

A user can perform a search and receive desired search results by selecting a search word relating to the current on-air program and a real-time hot-topic using the remote controller.

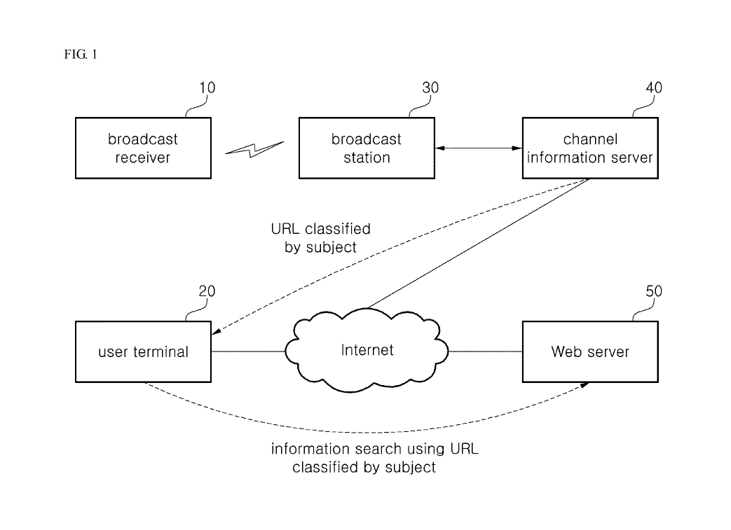

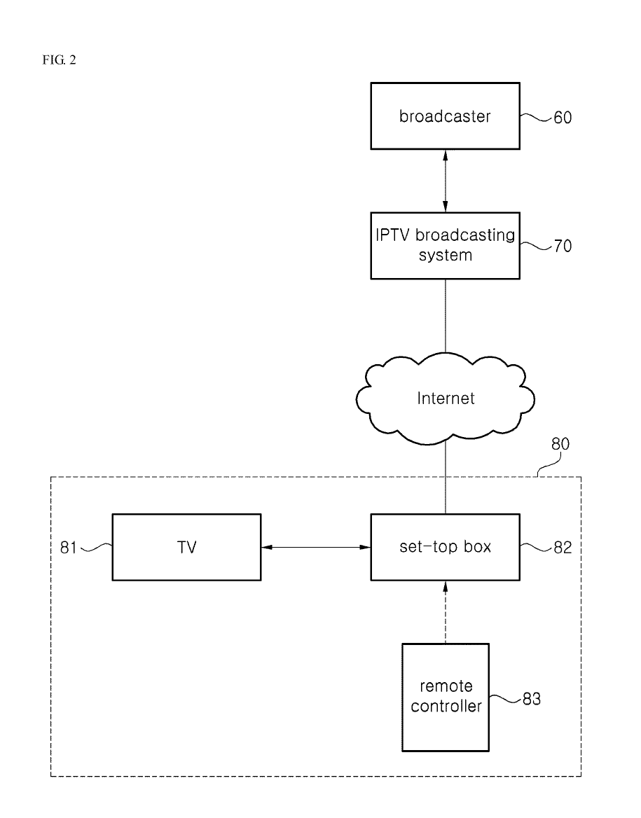

FIG. 1 is a diagram of a system capable of searching for additional information of broadcast content, according to exemplary embodiments of the present invention. As shown in FIG. 1, the system includes a broadcasting receiver 10, a user terminal 20, a broadcasting station 30, a channel information server 40, and a Web server 50. The broadcasting receiver 10 is configured to receive broadcast content from the broadcasting station 30. In some example, the broadcasting receiver can be any terminal including a TV. The channel information server 40 can provide uniform resource locator (URL) information to identify a resource with respect to additional information of each of broadcast content provided from the broadcasting station 30. When a user wants to search for additional information of on-air broadcast content, the user may request the URL information from the channel information server 40 via the user terminal 20. The channel information server 40 can send URL information being classified by subject of programs to the user terminal 20. The user terminal may search additional information via the Web server 50 using the URL information classified according to the subject.

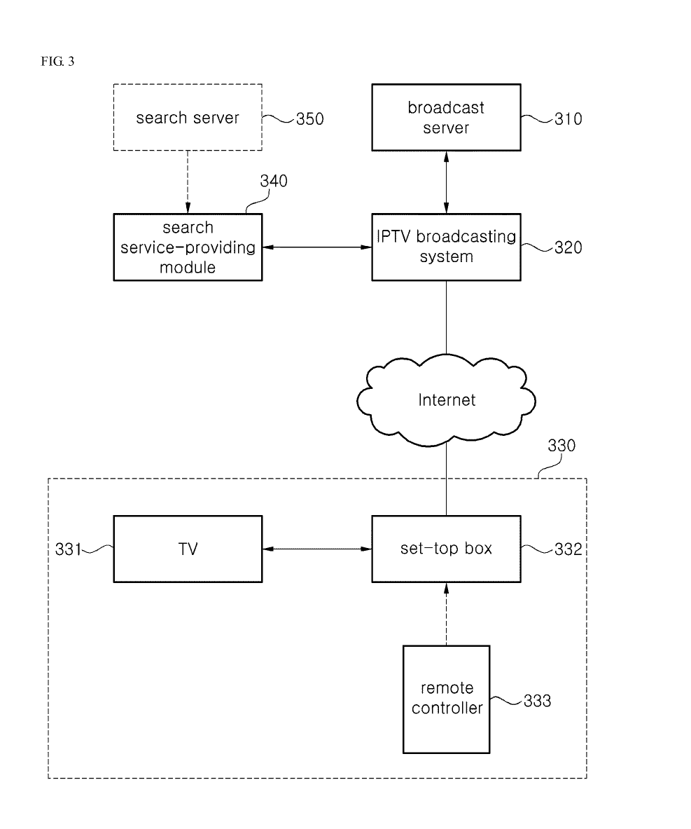

FIG. 2 is a diagram of an IPTV broadcast service system deploying a broadcaster 60, a set-top box, and a user terminal configured to provide broadcast service, according to exemplary embodiments of the present invention. Referring to FIG. 2, the IPTV broadcasting service system may include a broadcaster 60, an IPTV broadcasting system 70, and a user terminal 80. The IPTV broadcasting system 70 may include a storage server to store broadcast contents, and a control server (not shown) to send the broadcast content to the user terminal 80. The control server can process an input signal requested by a user. In some example, a distribution server is configured to distribute the broadcast content.

The IPTV broadcasting system 70 can manage broadcasting functions associated with offering program content from a content provider (CP) or the broadcaster 60. The broadcasting system can distribute program contents to a subscriber to provide broadcasting/recording/reproducing function services. For example, a program content provided by the content provider (CP) or the broadcaster 60 may include additional information related to other functions for broadcast services.

The user terminal 80 may be a device capable of receiving an Internet broadcast service and transmitting an input activity requested by a user. The terminal 80 may include, for example, a TV 81, a set-top box 82, and a remote controller 83. The TV 81 may output the broadcast content sent from the IPTV broadcast system 70 and may send the user request signals associated with input activity using the remote controller 83 to the IPTV broadcast system 70 via the return channels of the set-top box 82.

In some examples, a database may store a program for play time, information associated with a biography of an actor/an actress and product information can be established and search results can be obtained by a search module that are reconstructed into a carrousels for outputting function of data broadcasting. Data provided to a viewer including information of the biographies and the product information can be selected by a user using a data channel.

The broadcasting system may provide an access to a web site providing a user with a program and may allow the viewer to searching for at least one piece of text information, audio information, video information, or application information of the program. The connection to the web site may be achieved by selecting at least one of a tag, a search engine, or a web-site address services provided according to an electronic program guide (EPG), which corresponds to the television program currently being broadcasting to a user.

In some examples, a plurality of subjects related to a specific program may be selected and a hyperlink for the subjects may be assigned to any one of user-terminal accessible servers that can store a program timing file. The hyperlink may define time sections with respect to the selected subject of the program and may store the program timing file associated with the time sections. A user terminal connected to a network can search a targeted address associated with the hyperlink.

The broadcasting system may search information relating to a subject via a channel server that may provide broadcast program based on a Universal Coordinated Time.

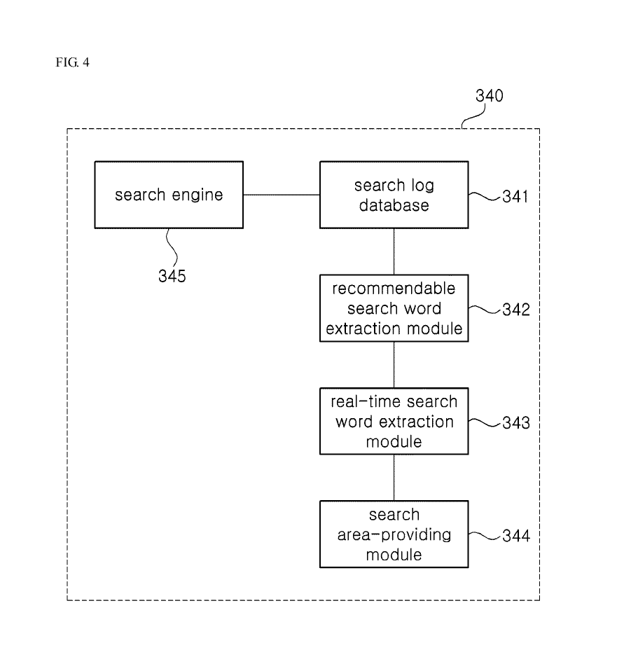

FIG. 3 is a diagram of a system capable of providing a searching service during a program, according to exemplary embodiments of the present disclosure.

The system as shown in FIG. 3 is capable of providing a search service during a program that may include a broadcast server 310, an IPTV broadcasting system 320, a user terminal 330, and a search service-providing module 340.

Referring to FIG. 3, the broadcast server 310 may provide a variety of broadcast contents. The IPTV broadcasting system 320 may include a storage server to store the broadcast contents, a return-pass server to process user request signals, for example, a program recommendation signal, an additional information request signal, and an input signal from a return channel. The system 320 may further include a distribution server to distribute the broadcast contents.

For the illustration purpose, it is noted that the term “broadcast content” may include any kinds of programs provided by an over-the-air broadcast station or a cable broadcasting station based on a program schedule, and video on demand (VOD) services provided by a communication service provider, and exemplary being referred to as a “TV program” or a “program”.

The user terminal 330 can be a device capable of using an Internet broadcast service including for example, a TV 331, a set-top box 332 and a remote controller 333 as a user input unit. The user terminal 330 may replay broadcast content from the IPTV broadcasting system 320 and may transmit a user request signal to the IPTV broadcasting system 320 via a return channel of the set-top box 332 after receiving the user request signal generated from the remote controller 333.

For example, the user terminal 330 may employ a terminal to one of an IP set-top box-embedded TV, an IP set-top box being connected to the user terminal 330, for example, a TV, a desktop computer, and a personal digital assistant.

The IP set-top box may include four layers and a hardware layer may represent a set-top box hardware, such as a central processing unit (CPU), a media processor, a flash random-access memory (RAM), and an Ethernet module. A system software layer may represent device drivers, and operating systems. A middleware layer may provide a process of running a Java Virtual Machine (JVM), a conditional access system (CAS) module, a Digital Rights Management (DRM) module, and stripping protocols (RTP, RTSP) being associated with the JVM, CAS and DRM modules. An application layer may support various codecs such as MPEG2, MPEG4, MPEG7, H.264, and WMV-9. The application layer may include an electronic program guide (EPG) to select IPTV service channels. For example, IPv4 addresses or IPv6 addresses can be assigned to an IP set-top box of a subscriber.

The search service-providing module 340 may provide an Internet portal site which has a search engine. When a plurality of users connects to the Internet portal site and searches for TV program-related search words, the search service-providing module 340 may store a search word log data of each of the users in a search log database 341, may collect search words to generate a search word pool with respect to TV programs based on the search word log data. The search service-providing module 340 may generate and may provide a recommendable search word (e.g., a keyword) and a modified word (e.g., similar or opposite words) of the recommendable search word based on the search word pool that can predict useful search information for the users with regard to broadcast programs currently being watched by the users.

The recommendable search word includes a representative keyword of a current on-air program and a search word associated with a current on-air program.

The search service-providing module 340 may provide a real-time hot-topic search word and modified words (similar or opposite word) of the real-time hot-topic search word. Although a real-time hot-topic search word may be related to a certain TV program or not related to the TV program, a search word related to the TV program is likely to be provided with an extended clipboard feature (e.g., spike) during broadcasting of the TV program.

The real-time hot-topic search word may be provided by a search engine of the search service-providing module 340. The real-time hot-topic search word may be provided by a separate search engine 350 coupled to the search service-providing module 340.

The search service-providing module 340 may provide a search area to provide a search service to the user terminal 330 in response to key input of the remote controller 333 as a user input unit during a program.

The search area may include a first search window configured to display a representative keyword of a current on-air program as an input search word, a second search window adjacent to the first search window is configured to display a search word relating to the current on-air program and the search word being as an completion of input, and a third search window adjacent to at least one of the first or second search windows configured to display a real-time hot-topic search word as an automatic input scheme.

For example, the search word automatically being as an input with a completion form of the second search window and the real-time hot-topic search word automatically being as an input to the third search window may be changed in a rolling manner. Further, when the second and third search windows are selected by a user, each of the second and third search windows may provide an extended pop-up window including a modified word (similar or opposite word) of the search word. The searching area may be adjustable in terms of display position and may turn to be a transparent mode to prevent the search area from blocking the program currently being watched by the user.

Accordingly, when a user pushes a certain key of the input unit such as the remote controller 333 while watching a certain TV program, the search service-providing module 340 may examine the program servicing on the air and may provide a representative keyword and a recommendable keyword relating to the program to a user allowing the user to perform a search by selecting a specific keyword among the representative keyword and the recommendable keyword, so that the user can easily search the Internet information relating to the program servicing on the air despite a restricted condition due to the limitation of input functions of an input unit such as the remote controller 333. It is noted that the system may provide a search service during a program.

FIG. 4 is a block diagram of the system for providing a search service during a program according to exemplary embodiments of the present invention. As shown in FIG. 4, the system may include a search log database 341 coupled to a search engine 345. The system may further include a recommendable search word extraction module 342, a real-time search word extraction module 343, a search area-providing module 344, and a search engine 345.

The search log database (DB) 341 may store search log data communicated via the search engine 345. The search log data is associated with a specific search word, for example, different meaning of search word of a user for searching for a TV program, and a search word and its content of the searched word is overlapping with or continuous to the content of a title of a TV program.

For example, the search log DB 341 may include a search word pool ranging from the associated search words corresponding to the specific search word to data directly input by broadcasting providers e.g., —pre-collected program information and caption/title information simultaneously transmitted with the corresponding program.

The recommendable search word extraction module 342 may generate a recommendable keyword of respective programs and may generate a modified keyword (similar or opposite word) of the recommendable keywords based on the search log database 341.

FIG. 5 is a diagram of providing a recommendable search word extraction module 342 by generating a recommendable keyword searching scheme for each program according to exemplary embodiments of the present invention. As shown in FIG. 5, a system may generate recommendable keywords of respective programs and a modified keyword (e.g., similar or opposite words) of the recommended keyword. The recommendable search word extraction module 342 may include a predictable viewer extraction module 342a, a recommendable keyword determination module 342b, a TV program-keyword time synchronization module 342c, a seed keyword DB 342d, a predictable viewer DB 342e, and a TV program recommendable keyword DB 342f.

The recommendable search word extraction module 342 may be operated associated with either a search server 350 or the search engine 345. The recommendable search word extraction module 342 may employ information of the search log DB 341 that can store a data log of search queries that can be transmitted to a search server 350 or a search engine 345.

For example, when a TV program is played on the user terminal 330, keyword search relating to the broadcasting TV program can be mainly operated by the user terminal 330 before or after broadcasting the TV program. Search queries may include search words, search times, and user identification numbers of the search log DB 341.

As embodied in the recommended search word extraction module 342 as shown in FIG. 5, the predicted viewer extraction module 342a can be coupled to the search engine 345 and the seed keyword DB 342d. The search engine 345 may be replaced with an external search server 350 which provides Web retrieval.

The seed keyword DB 342d may store a basic keyword, including a seed keywords relating to a certain TV program that can be matched to a broadcasting time. For example, the seed keyword may be a title of the TV program or a modified word of the tile of the TV program.

The seed keyword may be stored in a depository being differently categorized by imparting different weight value to the seed keyword. For example, for a drama category, a first category may include a title of a TV program and a character name of the TV program. And a second category may include a name of an actor, actress and of producing team members. It is noted that the first category having a higher possibility of search result may have a higher weight value than that of the second category.

The predictable viewer extraction module 342a may check whether there exist a seed keyword stored in the seed keyword DB 342d among search words received in the search server 350 or the search engine 345. The checking process performed by the extraction module 342a may require to be processed within a predetermined time threshold before and after a TV program broadcasting time. The predictable viewer extraction module 342a may extract an identification number of a user who searches for the seed keyword.

For example, any viewer corresponding to the extracted user identification number may be classified as a predicted viewer. In some examples, a user searching for the seed keyword with a critical number of times may be classified as the predictable viewer.

If an automatic completion function is provided to the search window, a user may select a search keyword generated by automatic completion function that may be classified as the predictable viewer. It is noted that a keyword selected by a user, for example, a popular keyword, a recommendable search word, and a real-time hot-topic search word being provided by the search engine 345 may be excluded from servicing to the predictable viewer.

In some examples, when a predictable viewer is extracted, the user identification number of the predictable viewer can be stored in the predictable viewer DB 342e. In the predictable viewer DB 342e, the user identification number can be stored so as to be matching with a number of a program, a series programs or groups of specific programs.

The recommendable keyword determination module 342b may collect the search words, which can be used by the predictable viewer during the broadcasting time corresponding to a TV program by referring to a reference of the predictable viewer DB 342e. When a collection of a certain search word satisfies a predetermined criteria, the recommendable keyword determination module 342b may determine the collected search word as a keyword and may add the collected search word to a keyword set. The predetermined criteria may be satisfied when a degree of correlation between the search word and the corresponding TV program shows a critical value.

The recommendable determination module 342b may determine a keyword whether the recommendable keyword corresponding to a TV program may satisfy the predetermined criteria. And the recommendable determination module 342b may generate a keyword set for the corresponding TV program.

The TV program-keyword time synchronization module 342c may serves to match a keyword of the keyword set to broadcasting time of TV programs. For example, the TV program-keyword time synchronization module 342c may select a high ratio keyword presented during broadcast time based on a number of searching time, for example, during an interval of sixty (60) seconds with respect to a keyword in each broadcasting time.

During a matching keyword process performed by the TV program-keyword time synchronization module 342c, a predetermined unsuitable keyword may be filtered. For example, keyword, for example, live broadcasting, rebroadcasting, viewing, program organization, and program broadcasting time may be removed as an unsuitable keyword. Since the search log DB 341 may also store information during the search time with respect to a keyword being selected as a recommendable keyword, a synchronization of matching process may be performed by matching the keywords of the keyword being selected to the respective broadcasting time of TV program.

The keyword being matched to the respective TV program may be stored in the TV program recommended keyword DB 342f. When a subsequent broadcasting content of the same TV program is broadcasting, a recommendable keyword of the corresponding program may be provided in real-time basis. Those of ordinary skill in the art understood that the configuration and operation of the recommendable search word extraction module 342 can be operated with other algorithms.

The real-time search word extraction module 343 may extract a real-time hot-topic search word and a TV program-related real-time hot-topic search word, and may generate a modified word (similar or opposite word) of the real-time hot-topic search word.

The TV program-related real-time hot-topic search word may be extracted from TV program-related popular search words based on a number of searching, after TV program-related search words can be processed by the search server 350. The search engine 345 can be classified, for example, based on program organization-table data, and program-related information provided by the broadcasting provider server 310.

In some examples, although the real-time hot-topic search word may be generated independently to a current on-air program, the real-time hot-topic search word may also be generated according to a searching behavior of a viewer while watching the current on-air program in concurrent manner. The real-time hot-topic search word can be a complementary searching scheme to satisfy a real-time search requirement.

Although the real-time hot-topic search word is illustrated as a real-time search word extraction module 343, the real-time hot-topic searching scheme may be performed by a separate search server 350 that can be coupled to the search service providing unit 340.

While watching broadcast service, the search area-providing module 344 may provide a search area for search service to the user terminal 330 in response to key input generated by the remote controller 333 as a user input unit.

The search area may include a first search window configured to display a representative keyword of a current on-air program and the representative keyword may automatically being as an input of a search word, and may include a second search window adjacent to the first search window configured to display a search word relating to the current on-air program and the search word may automatically being as an input of a completion form of the search word. Further, the search area may include a third search window may configured to reside adjacent to at least one of the first search window or second search window to display a real-time hot-topic search word may automatically being as an input.

The first search window may display a representative keyword, for example, a title of program of current broadcasting program which may automatically displayed as an input. The second search window may display a keyword relating to the current on-air program and the keyword may automatically being as an input of a completion form of search word. The keyword automatically displayed as an input of the completion form of the second search window may be selected from a keyword relating to the current on-air program, and the keyword has been collected among the search log data collected by an external search server 350 or a search engine 345.

The third search window may display a real-time hot-topic search word automatically displayed as an input. The search service providing unit 340 may allow the real-time hot-topic search word to be automatically as an input to the third search window while representing a real-time search result of a user being connect to an Internet portal site including a search server.

A search word automatically displayed as an input to the second search window and a real-time hot-topic search word automatically displayed as an input to the third search window may be changed in a rolling manner. In addition, when one of the first, second or third search window is selected by a user, an extended pop-up window including a modified word (e.g., similar or opposite word) may be providing as a final search word.

The modified word (similar or opposite word) of the extended pop-up window may include another search word including a partial text of the recommendable keyword and a real-time hot-topic search word.

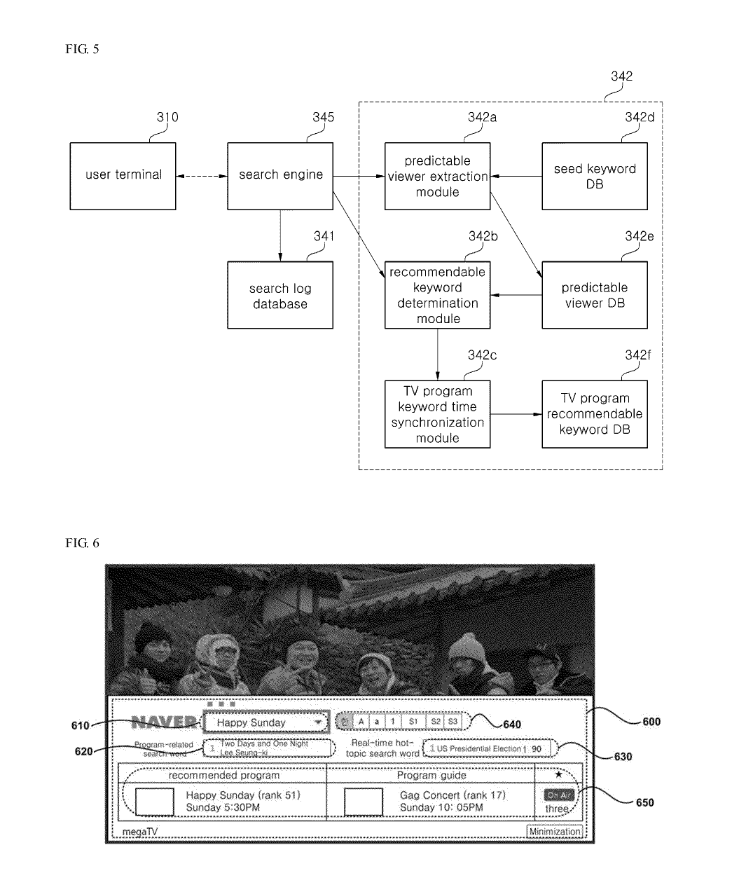

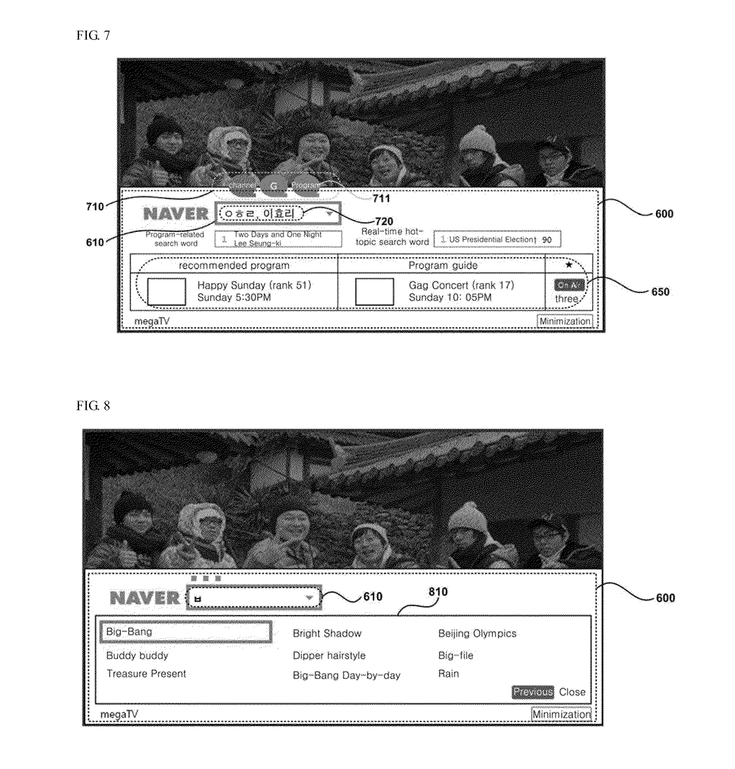

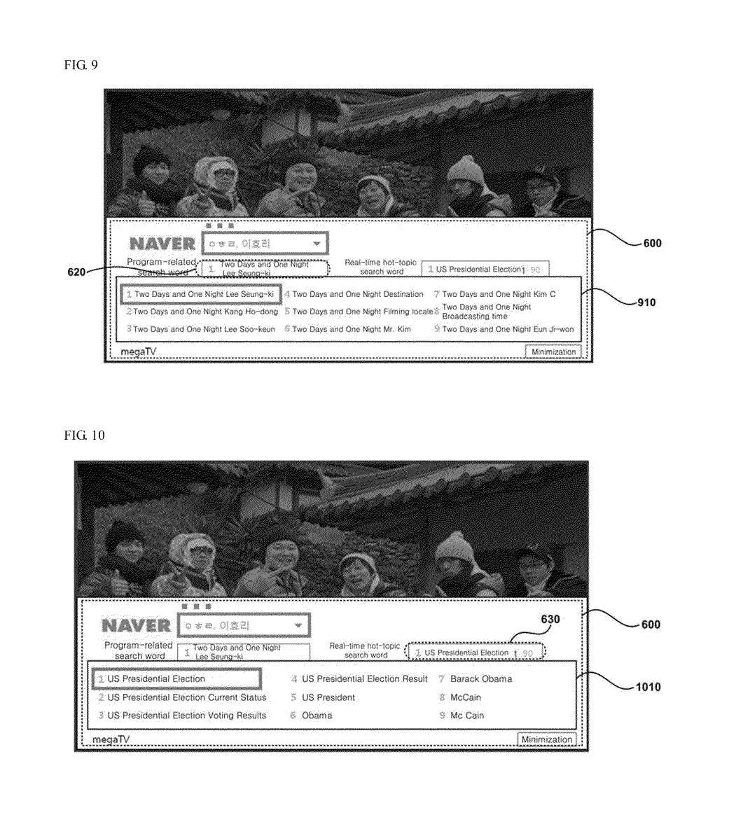

FIG. 6, FIG. 7, FIG. 8, FIG. 9 and FIG. 10 are graphical screen showing searching areas displayed on a terminal for providing a search service functions during a program according to exemplary embodiments of the present invention.

For the illustration purpose, it is assumed that depicted graphical screen shots are relating to an on-air TV program currently watched by a viewer is “Happy Sunday Two Days and One Night” broadcast by “Korean Broadcasting System (KBS)”.

FIG. 6 is a graphical screen of a search area displayed on a TV screen by a system for providing a search service functions during a program. As shown in FIG. 6, a search area 600 may provide a search service during a program including a first search window 610, a second window 620, and a third search window 630. The first search window 610 may display a representative keyword (e.g., Happy Sunday) of a currently broadcasting TV program (e.g., “Happy Sunday Two Days and One Night,” KBS) as an input, the second window 620 may display a program-related search word (e.g., “Two Days and One Night,” Lee Seungki) and the search word may automatically be provided as an input in a completion form of input word. And the third search window 639 may display a real-time hot-topic search word (e.g., U.S. presidential Election) automatically being as an input.

In addition, the search area 600 may further include a letter conversion key 640 for facilitating to type a search word as an input, and a search result window 650 for displaying a search result, for example, a recommendable TV program.

As shown in FIG. 6, the search area 600 may include a bar shape may residing at a lower portion of the TV screen while a screen of overlapping of the program can be occupied at the whole TV screen. The screen area 600 may be adjusted with a transparent mode to prevent the search area 600 from blocking of the program being played on a TV screen.

The search service providing unit 340 may further include a screen processor (not shown) for processing a function of the screen area 600 to display a service to the user terminal 330. The screen processor may reside in a user terminal 330.

Although the search area 600 may be illustrated with a bar shape residing at the lower portion of the TV screen as shown in FIG. 6, the search area may be configured to reside at any location including a left, a right and an upper side of the TV screen by the screen processor.

FIG. 7 shows a search area displayed on the TV screen for providing a search service during a program. In FIG. 7, an icon window 710 is generated for providing a predetermined service and the icon window can be added to an upper side of the first search area 610 of the search area 600. The icon window 710 can be provided as a form of an icon instead of a full menu to minimize a size to display and may allow a service provider to perform a tailored service using each icon corresponding to an icon selected by a user according to a service request.

When a program guide icon 711 of the icon window 710 is selected, a separate program guide screen may be generated or a content relating to a program guide may be displayed on the search result window 650 of the search area 600.

The search area 600 may provide an automatic completion function window 720 which automatically show a search word relating to a first letter of a word when the first letter is an input to a first search window 610.

As shown in FIG. 8, the search area 600 may provide an extended pop-up window 810, which may include a modified word of a certain search word in a completed form, when the search word is input to the first search window 610 after a process of deleting the representative keyword of the program of the first search window 610.

When consonant letters, such as [symbol] or a combination of a character and the consonant letters, such as [symbol] can be an input as a search word into the first search window 610, the extended pop-up window 810 may provide an automatic completion function performing the incomplete input consonant letters to make a complete search word based processing of the incomplete consonant letters using the extended pop-up window 810.

The extended pop-up window 810 may include a modified word corresponding to the search word, and may provide a number of modified words corresponding to the search word can be displayed with a complete word via the extended pop-up window 810. A number of modified words of the search word being displayed in the extended pop-up window 810 can be limited according to a size of the search area by way of configuration.

Referring to FIG. 9, a second search window 620 of the search area 600 may display a program-related search word automatically being as an input with a completion form of searchword, and the input search word may be changed in a rolling manner in that the input search word changes each time when user instructs to change the search word.

When a user points a focus of the second search window 620 using a direction key of the remote controller 333 and activates a confirmation key, an extended pop-up window 910 can be exposed and allowing a focus be positioned on respective search word until the search word is finally displayed of the second search window 620. The display of a focus of search words can be changed in the rolling manner in that the focus may change each time when user instructs to changing a focus pointing.

When a user pushes the confirmation key of the remote controller 333 after pointing a focus on a desired search word of the extended pop-up window 910 using the direction key of the remote controller 333, a retrieved page of the selected search word may separately be opened or may be displayed on the search result window 650 as shown in FIG. 6 and FIG. 7.

When a user points a focus on the third search window 630 using a direction key of the remote controller 333 and activates the confirmation key, an extended pop-up window 1010 can be exposed and allows the focus to be positioned at a search word which may be a final search word displayed on the third search window 630 and the final search word can be displayed among input search words and each of the input search words automatically is generated and changed in a rolling manner in that the search word can be changed until the final search word is selected by a user.

When the user points a focus to a desired search word of the extended pop-up window 1010 using a direction key of the remote controller 333 and selects a desired search word using the remote controller 333, a retrieved page of the selected search word may separately be opened or may be displayed on the search result window 650 as shown in FIG. 6 and FIG. 7.

For facilitating search service, the respective search windows 610, 620, 630 can be formed adjacent to each other in the search area 600, thus the system allows a user to perform search activity with an intuitive manner.

For example, the system by providing a usable search service during broadcasting a program allows a user to perform a search with an answer per a certain question faced while watching broadcasting TV program, using a program-related search word or a real-time hot-topic search word provided for searching the Internet at a TV screen without using a personal computer (PC) or other media for searching the answer per question.

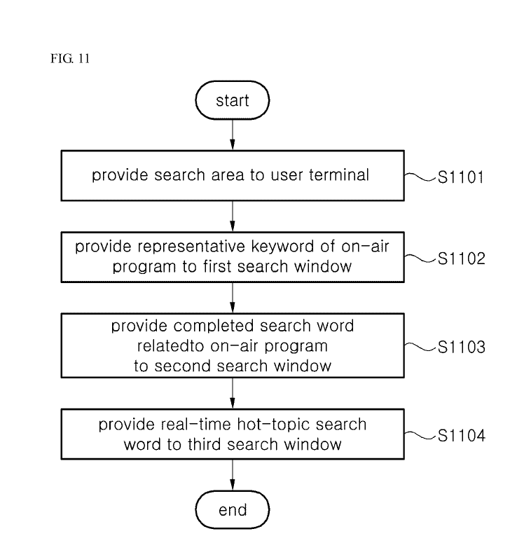

FIG. 11 is a flowchart of a process for providing a search service during a program according to exemplary embodiments of the present invention.

A system may receive a search service request from a user terminal and may determine whether the search service request from a user matches with rule of a search engine associated with various search providing module.

As in step S1101, the search area-providing module 344 may provide a search area for performing a search service to the user terminal 330 in response to key input on a user input unit.

The search area-providing module 344 may provide a representative keyword of an on-air program, extracted from the recommended search word extraction module 342, to a first search window of the search area, per step S1102.

The search area-providing module 344 may provide a program-related search word, extracted in a completed form from the recommended search word extraction module 342, to a second search window adjacent to the first search window of the search area, per step S1103.

The search word automatically being as an input to a second search window can be selected from collected keywords, which can be related to a on-air program among search log data selected by the search server 350 or the search engine 345. And the search word may be changed with a rolling manner.

In step S1104, the search area-providing module 344 may provide a real-time hot-topic search word, extracted from the real-time search word extraction module 343, to a third search window adjacent to one of a first search window or a second search window of the search area.

For example, the second and third search windows may be selected by a user, or an extended pop-up window including modified words of a selected search word may be provided. Further, the search area may be adjustable with a transparent mode and broadcast content can be displayed to a screen. In addition, a position of the search area of the screen of the terminal may be adjustable to facilitate search.

When a certain search word, being displayed on one of the first, the second or the third search windows, is selected, the search area-providing module 344 may display a search result after sending the selected search word to the search engine 345 for processing and receiving the search result from the search engine 345.

For example, the search result may be provided by processing a search result of a search server of Web search service for the IPTV.

The processes described herein for developing, executing, and/or modifying customized search service may be implemented via software, hardware (e.g., general processor, Digital Signal Processing (DSP) chip, an Application Specific Integrated Circuit (ASIC), Field Programmable Gate Arrays (FPGAs), firmware or a combination thereof. Such exemplary hardware for performing the described functions is detailed below.

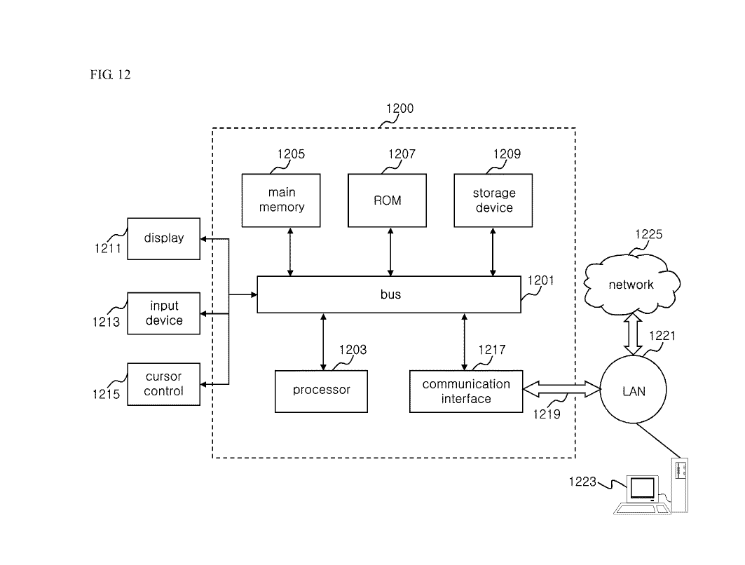

FIG. 12 illustrates computing hardware (e.g., computer system) 1200 upon which an embodiment according to the invention can be implemented. The computer system 1200 includes a bus 1201 or other communication mechanism for communicating information and a processor 1203 coupled to the bus 1201 for processing information. The computer system 1200 also includes main memory 1205, such as a random access memory (RAM) or other dynamic storage device, coupled to the bus 1201 for storing information and instructions to be executed by the processor 1203. Main memory 1205 can also be used for storing temporary variables or other intermediate information during execution of instructions by the processor 1203. The computer system 1200 may further include a read only memory (ROM) 1207 or other static storage device coupled to the bus 1201 for storing static information and instructions for the processor 1203. A storage device 1209, such as a magnetic disk or optical disk, is coupled to the bus 1201 for persistently storing information and instructions.

The computer system 1200 may be coupled via the bus 1201 to a display 1211, such as a cathode ray tube (CRT), liquid crystal display, active matrix display, or plasma display, for displaying information to a computer user. An input device 1213, such as a keyboard including alphanumeric and other keys, is coupled to the bus 1201 for communicating information and command selections to the processor 1203. Another type of user input device is a cursor control 1215, such as a mouse, a trackball, game pad, instrumented sports equipment, voice recognition technology, or cursor direction keys, for communicating direction information and command selections to the processor 1203 and for controlling cursor movement on the display 1211.

According to an embodiment of the invention, the processes described herein are performed by the computer system 1200, in response to the processor 1203 executing an arrangement of instructions contained in main memory 1205. Such instructions can be read into main memory 1205 from another computer-readable medium, such as the storage device 1209. Execution of the arrangement of instructions contained in main memory 1205 causes the processor 1203 to perform the process steps described herein. One or more processors in a multi-processing arrangement may also be employed to execute the instructions contained in main memory 1205. In alternative embodiments, hard-wired circuitry may be used in place of or in combination with software instructions to implement the embodiment of the invention. Thus, embodiments of the invention are not limited to any specific combination of hardware circuitry and software.

The computer system 1200 also includes a communication interface 1217 coupled to bus 1201. The communication interface 1217 provides a two-way data communication coupling to a network link 1219 connected to a local network 1221. For example, the communication interface 1217 may be a digital subscriber line (DSL) card or modem, an integrated services digital network (ISDN) card, a cable modem, a telephone modem, or any other communication interface to provide a data communication connection to a corresponding type of communication line. As another example, communication interface 1217 may be a local area network (LAN) card (e.g. for Ethernet™ or an Asynchronous Transfer Model (ATM) network) to provide a data communication connection to a compatible LAN. Wireless links can also be implemented. In any such implementation, communication interface 1217 sends and receives electrical, electromagnetic, or optical signals that carry digital data streams representing various types of information. Further, the communication interface 1217 can include peripheral interface devices, such as a Universal Serial Bus (USB) interface, a PCMCIA (Personal Computer Memory Card International Association) interface, etc. Although a single communication interface 1217 is depicted in FIG. 12, multiple communication interfaces can also be employed.

The network link 1219 typically provides data communication through one or more networks to other data devices. For example, the network link 1219 may provide a connection through local network 1221 to a host computer 1223, which has connectivity to a network 1225 (e.g. a wide area network (WAN) or the global packet data communication network now commonly referred to as the “Internet”) or to data equipment operated by a service provider. The local network 1221 and the network 1225 both use electrical, electromagnetic, or optical signals to convey information and instructions. The signals through the various networks and the signals on the network link 1219 and through the communication interface 1217, which communicate digital data with the computer system 1200, are exemplary forms of carrier waves bearing the information and instructions.

The computer system 1200 can send messages and receive data, including program code, through the network(s), the network link 1219, and the communication interface 1217. In the Internet example, a server (not shown) might transmit requested code belonging to an application program for implementing an embodiment of the invention through the network 1225, the local network 1221 and the communication interface 1217. The processor 1203 may execute the transmitted code while being received and/or store the code in the storage device 1209, or other non-volatile storage for later execution. In this manner, the computer system 1200 may obtain application code in the form of a carrier wave.

The term “computer-readable medium” as used herein refers to any medium that participates in providing instructions to the processor 1203 for execution. Such a medium may take many forms, including but not limited to non-volatile media, volatile media, and transmission media. Non-volatile media include, for example, optical or magnetic disks, such as the storage device 1209. Volatile media include dynamic memory, such as main memory 1205. Transmission media include coaxial cables, copper wire and fiber optics, including the wires that comprise the bus 1201. Transmission media can also take the form of acoustic, optical, or electromagnetic waves, such as those generated during radio frequency (RF) and infrared (IR) data communications. Common forms of computer-readable media include, for example, a floppy disk, a flexible disk, hard disk, magnetic tape, any other magnetic medium, a CD-ROM, CDRW, DVD, any other optical medium, punch cards, paper tape, optical mark sheets, any other physical medium with patterns of holes or other optically recognizable indicia, a RAM, a PROM, and EPROM, a FLASH-EPROM, any other memory chip or cartridge, a carrier wave, or any other medium from which a computer can read.

Various forms of computer-readable media may be involved in providing instructions to a processor for execution. For example, the instructions for carrying out at least part of the embodiments of the invention may initially be borne on a magnetic disk of a remote computer. In such a scenario, the remote computer loads the instructions into main memory and sends the instructions over a telephone line using a modem. A modem of a local computer system receives the data on the telephone line and uses an infrared transmitter to convert the data to an infrared signal and transmit the infrared signal to a portable computing device, such as a personal digital assistant (PDA) or a laptop. An infrared detector on the portable computing device receives the information and instructions borne by the infrared signal and places the data on a bus. The bus conveys the data to main memory, from which a processor retrieves and executes the instructions. The instructions received by main memory can optionally be stored on storage device either before or after execution by processor.

It will be apparent to those skilled in the art that various modifications and variations can be made in the present invention without departing from the spirit or scope of the invention. Thus, it is intended that the present invention cover the modifications and variations of this invention provided they come within the scope of the appended claims and their equivalents.

1. A method, comprising:
receiving a search request from a user terminal during a broadcast program;
determining whether the search request matches with criteria of a search engine for providing a first search window to the search area, wherein the first search window is to display a representative keyword that is automatically provided as an input for searching, wherein the criteria for the matching is based on an identification of the broadcast program;
determining whether the search request matches with the criteria for providing a second search window formed adjacent to the first search window, wherein the second search window is to display a search word that is related to the broadcast program and the search word is a completed search word automatically being provided as an input;
determining whether the search request matches with the criteria for providing a third search window formed adjacent to at least one of the first search window and the second search window, wherein the third search window is to display a real-time hot-topic search word automatically being provided as an input; and
is providing a search window based on the determination.

2. The method of claim 1, further comprising:
sending a selected search word to the search engine to determine whether the search word is automatically provided as an input to any one of the first search window, the second search window or a the third search window; and
receiving a search result from the search engine to display the search result to the search area.

3. The method of claim 1, wherein the search word, automatically being provided as an input to the second search window or the third search window, is changed in a rolling rule.

4. The method of claim 1, wherein the search area is adjustable to a transparent mode and a position of the search area of the screen of the terminal is adjustable to facilitate search.

5. The method of claim 1, wherein the second search window and the third search window provide an extended pop-up window comprising a modified word of the search word displayed on the respective search window when the corresponding search window is selected.

6. The method of claim 5, wherein the extended pop-up window comprises a modified word of a search word being displayed as a final search word on the corresponding search window.

7. A method for providing a search service, the method comprising:
receiving a search service request from a bidirectional broadcasting terminal in response to an input key of a user input unit;
determining the search service request based on a rule of a search engine comprising a search providing module according to the determination of the input key action based on the rule;
populating a first search window, the first search window displaying a representative keyword automatically being selected as the input key based on an identification of a broadcast content;
populating a second search window, the second search window to display a search word relating to the broadcast content and the search word automatically being selected as the input key with a completion of the search word; and
populating a third search window, the third search window to display a real-time hot-topic search word automatically being selected as the input key, wherein the populating the respective search window is based on the determination according the rule of the search engine.

8. The method of claim 7, wherein the second search window and the third search window to provide an extended pop-up window comprising a modified word of the search word displayed on the respective search window in response to a selection of the corresponding search window.

9. The method of claim 7, wherein the third search window is formed being adjacent to at least one of the first search window or the second search window and the first search window and the second search window are arranged by way of configuration of the search window for facilitating search activity.

10. A system, comprising:
a search log database to store search log data collected by a search engine;
a recommendable search word extraction module to generate a program related keyword and a modified word of the program related keyword based on the search log data;
a real-time search word extraction module to generate a real-time hot-topic search word and a modified word of the real-time hot-topic search word based on the search log data; and
a search area-providing module to provide a search area comprising a plurality of search windows in response to a search service request from a bidirectional broadcasting terminal, the plurality of search windows to display the program-related keyword and the real-time hot-topic search word automatically being displayed as an input.

11. The system of claim 10, wherein the plurality of search windows are configured to provide an extended pop-up window comprising the modified word of the program related keyword or a modified word of the real-time hot-topic search word automatically displayed as an input in response to a selection of the corresponding search window.

12. The system of claim 10, wherein the plurality of search windows comprises a first search window to display a representative keyword of the program automatically displayed as an input, a second search window being adjacent to the first search window and the second search window to display the program-related keyword automatically displayed as an input, and a third search window being adjacent to at least one of the first search window or the second search windows to display the real-time hot-topic search word automatically displayed as an input.

13. The system of claim 10, wherein the search area-providing module is configured to provide the extended pop-up window that provides a modified word comprising a text input to the first search window.

14. The system of claim 12, wherein the text input to the first search window comprises first letters of a word.

15. The system of claim 10, wherein the search area-providing module is configured to change the keyword and the real-time hot-topic search word automatically displayed as an input to the second search window and the third search windows in a rolling manner.

16. A non-transitory computer-readable recording medium comprising an executable program, which when executed, performs the steps of:
providing a search area for providing a search service on a screen of the bidirectional broadcasting terminal in response to key input of a user input unit;
receiving a search request from a user terminal during a broadcast program;
determining whether the search request matches with criteria of a search engine for providing a first search window to the search area, wherein the first search window is to display a representative keyword that is automatically provided as an input for searching, wherein the criteria for the matching is based on an identification of the broadcast program;
determining whether the search request matches with the criteria for providing a second search window formed adjacent to the first search window, wherein the second search window is to display a search word that is related to the broadcast program and the search word is a completed search word automatically provided as an input;
determining whether the search request matches with the criteria for providing a third search window formed adjacent to at least one of the first search window and the second search window, wherein the third search window is to display a real-time hot-topic search word automatically provided as an input; and
providing a search window based on the determination,
wherein each of the second search window and the third search window provides an extended pop-up window comprising a modified word of the search word displayed on the corresponding search window in response to a selection of the corresponding search window.
